(19) United States
(12) Patent Application Publication
(10) Pub. No.: US 2008/0239985 A1
(43) Pub. Date: Oct. 2, 2008

(54) METHOD AND APPARATUS FOR A SERVICES MODEL BASED PROVISIONING IN A MULTITENANT ENVIRONMENT

(75) Inventors: Alexei A. Karve, Mohegan Lake, NY (US); Ajay Mohindra, Yorktown Heights, NY (US); Randy A. Rendahl, Raleigh, NC (US); Alla Segal, Mount Kisco, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/693,750

(22) Filed: Mar. 30, 2007

(51) Int. Cl. H04L 12/28; G06F 15/173; G06F 15/177

(52) U.S. Cl. 370/254; 709/220; 709/226

(57) ABSTRACT

A method, system and computer usable program code is disclosed for mapping a logical topology to information technology (IT) resources. The method comprises the steps of generating a logical topology of resources for a solution to a given request for resources, extracting information about shared rules and constraints on IT resources specific to a plurality of customers, and generating multiple mappings from the logical topology to the IT resources that satisfy said shared rules and constraints.

### BACKGROUND OF THE INVENTION

1. Field of the Invention

The present invention relates generally to data processing systems and more particularly to a computer implemented method for software and systems management in networked computer environments. Still more particularly, the present invention provides a computer-implemented method, data processing system, and computer usable program code for providing a services model based provisioning in a multi-tenant environment.

2. Description of the Related Art

With the increasing popularity of service-oriented architectures, solutions are being developed with a service centric model. When a services-based solution needs to be deployed in a datacenter environment, the provisioning has to ensure that all the services that the solution uses have been provisioned and started. Failure to do so would cause the solution to fail at runtime.

The current approach to model based provisioning is to deploy and provision all aspects of the model without any concern for reuse or sharing across offerings. This is a perfectly valid model when security is of prime importance. However, on the downside, the existing models require dedicated resources, thereby increasing the cost of provisioning an offering.

The offering subscriber or tenant could be a small company that can benefit from advanced services but can not yet cost justify a major expenditure. The advantage for a tenant is that the company will not have to make the initial investment to purchase a full solution outright, and yet will have access to all services that otherwise might have not been affordable on their own, albeit maybe with relaxed service level agreements (SLAs). It would be economical to use shared services as opposed to owning or leasing a set of systems, software and maintenance.

Allocating of resources based on performance constraints, such as SLA, is known to the art. For example, U.S. Pat. No. 6,831,966 “Multi-tenant, multi-media call center services platform system” describes a call center system to enable communications between callers and subscribers. SLAs are used to determine how ports are allocated to each call. Multi-tenant framework is used to identify the subscriber or caller and to accept or reject calls. There is, however, nothing in U.S. Pat. No. 6,831,966 that suggests mapping a logical topology to IT resources or using shared rules and constraints. While SLAs can be viewed as one type of “constraints”, U.S. Pat. No. 6,831,966 simply uses performance constraints to determine the most efficient way to enable communications. U.S. Pat. No. 6,831,966 does not use shared rules nor can the method described there be used for allocating different types of IT resources to an offering or tenant using shared rules and constraints.

U.S. Patent Application Publication No. 2002/0099669 “Service Level Agreements/Virtual private Network Templates” describes system and method for generating SLA templates for networks. The graphical user interface is used to collect information about network node configuration, service classes and SLA constraints. While this publication describes creation of templates for constraints and physical topology for a single customer, the described method does not support a multiple plurality of customers nor does it address sharing.

U.S. Patent Application Publication No. 2002/0120720 “Method and System to precompile configuration information for a data communication device” describes a method to pre-compile configuration information for a network connection device; to generate rule program based on a rule that defines behavioral requirements for a network connection device and a file describing operations of a network connection device. This publication also discloses office environments in which remote offices of an enterprise share network services and use service level agreements to guarantee certain performance levels. While the described method converts configuration information into a rule program, it does not map a logical topology to IT resources. While it does apply SLA in cases where multiple users share a single network connection, it does not address the application of shared rules and constraints to customers or generation of mappings of IT resources to satisfy shared rules and constraints. Also, SLA is only type of constraints addressed here, and the only shared resource is a network connection.

U.S. Patent Application Publication No. 2003/0229759 “Processing Service Level Agreement Terms in Caching Components of a Storage System” describes a method for processing SLAs that includes monitoring groups of data in cache where each of the groups has an SLA, and evicting the members from groups with an over funded SLA. Nothing in this publication, however, suggests mapping a logical topology to IT resources, provisioning or sharing.

U.S. Patent Application Publication No. 2004/0034553 “Method and System for Prioritizing Business Processes in a Service Provisioning Model” describes a method of prioritizing a business process based on enabling technological components. While this reference addresses mapping an IT event to a business impact, the method described is not applicable to the mapping of logical topology to IT resources using shared rules and constraints.

U.S. Patent Application Publication No. 2004/0230681 “Apparatus and Method for Implementing Network Resources using an Information Model” describes “an apparatus and method for provisioning network services that includes different devices having different programming models and/or functionalities.” This patent application uses the business rules and policy management to create each individual device configuration i.e. to determine which command to use, at what time, which ports to enable, etc., but the reference does not determine which resources, can be shared across which customers. The method for configuring individual devices cannot be used to determine sharing of multiple resources nor can it be used to create mappings between a logical topology and IT resources.

U.S. Patent Application Publication No. 2005/0222885 “Method enabling real-time testing of on-demand infrastructure to predict service level agreement compliance” describes apparatus and method for demonstrating the efficiency and effectiveness of a customer's IT system and applications operating in a shared IT, or electronic business on-demand, environment. A test suite mimics hypothetical settings in an on-demand services environment and then determines how the settings affect the allocation of resources in the on-demand services environment. The calculated allocation of resources is then compared to one or more service level agreements (SLAs) in order to determine compliance with a particular SLA. This publication, however, does not address mapping logical topology to IT resources in order to create configuration that would satisfy shared rules and constraints to support a plurality of customers, nor does it determine said shared rules and constraints.

EP1349314A1 “Method for Monitoring Service Level Agreements” describes a method that involves updating a database with SLA data, detecting/storing SLA-related events, comparing with SLA-related data in the database and possibly generating a corresponding report. This reference also does not address resource allocation based on shared rules and constraints.

All of the existing work in resource sharing concentrates on sharing physical resources (such as blades) based on performance parameters such as CPU speed or anti-collocation constraints. What is missing, however, is the broader model of sharing that would consider sharing physical resources and services between tenants as well as between offerings.

### SUMMARY OF THE INVENTION

An object of this invention is to provide a services model based provisioning in a multi-tenant environment.

Another object of the present invention is to map a logical topology of information technology (IT) resources to a pool of those resources.

A further object of the invention is to map logical topology to IT resources in order to create a configuration of those resources that satisfies shared rules and constraints to support a plurality of customers.

Another object of the present invention is to provide a broad model of sharing IT resources that considers sharing physical resources and services between tenants as well as between offerings.

These and other objectives are attained with a method and system for mapping a logical topology to information technology (IT) resources. The method comprises the steps of generating a logical topology of resources for a solution to a given request for resources, extracting information about shared rules and constraints on IT resources specific to a plurality of customers, and generating multiple mappings from the logical topology to the IT resources that satisfy said shared rules and constraints.

For example, a preferred embodiment of the system of this invention comprises an offering manager, a data manager, a policy manager, and a provisioning manager. The Offering Manager receives requests to provision a new offering or to add a new tenant to an already provisioned offering and determines the offering's logical topology. Offering Manager then calls the Data Manager to obtain the information about the current configuration of the IT resources of the data center. The Offering Manager then queries the Policy Manager to determine which of any of the currently provisioned resources can be shared with the new offering based on existing sharing rules and constraints. The Offering Manager then calls the Provisioning Manager to provision the missing components and to configure the new offering/tenant to use shared components.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

Illustrative embodiments of the invention, as well as a preferred mode of use, further objectives and advantages thereof, may best be understood by reference to the following detailed description of the illustrative embodiments when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 uses an example of an existing topology of IT resources in a data center and the logical topology of the new deployment request to demonstrate the logical steps involved in the implementation of the illustrative embodiment;

FIG. 4 continues the example shown in FIG. 3 to demonstrate how the new deployment request's topology of IT resources can be mapped to the IT resources of the data center using sharing rules and constraints according to the illustrative embodiment;

FIG. 5 depicts a schematic representation of the logical architecture of a policy-based management system in accordance with an illustrative embodiment; and

FIGS. 6 and 7 contain a flowchart illustrating the steps performed by the system depicted in FIG. 5 in accordance with an illustrative embodiment.

### DETAILED DESCRIPTION OF THE PREFERRED EMBODIMENT

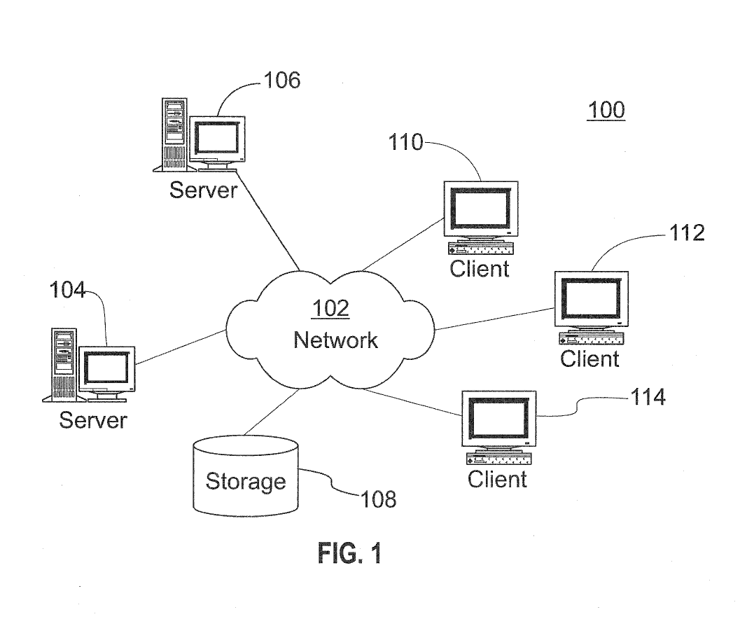

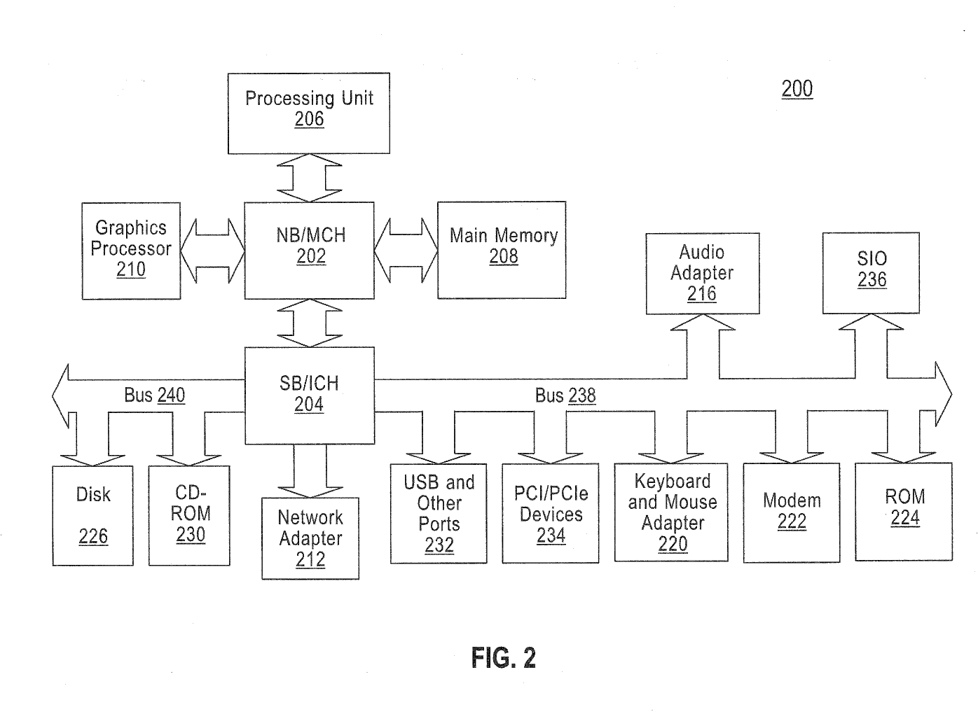

With reference now to the figures and in particular with reference to FIGS. 1-2, exemplary diagrams of data processing environments are provided in which embodiments of the invention may be implemented. It should be appreciated that FIGS. 1-2 are only exemplary and are not intended to assert or imply any limitation with regard to the environments in which embodiments may be implemented. Many modifications to the depicted environments may be made without departing from the spirit and scope of the present invention.

With reference now to the figures, FIG. 1 depicts a pictorial representation of a network of data processing systems in which illustrative embodiments may be implemented. Network data processing system 100 is a network of computers in which embodiments may be implemented. Network data processing system 100 includes network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, comprised of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes for embodiments may be located.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. The bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide for a computer-implemented method, data processing system, and computer usable program code for providing a services model based provisioning in a multi-tenant environment. The computer-implemented methods of the illustrative embodiments may be performed in a data processing system, such as data processing system 100 shown in FIG. 1 or data processing system 200 shown in FIG. 2.

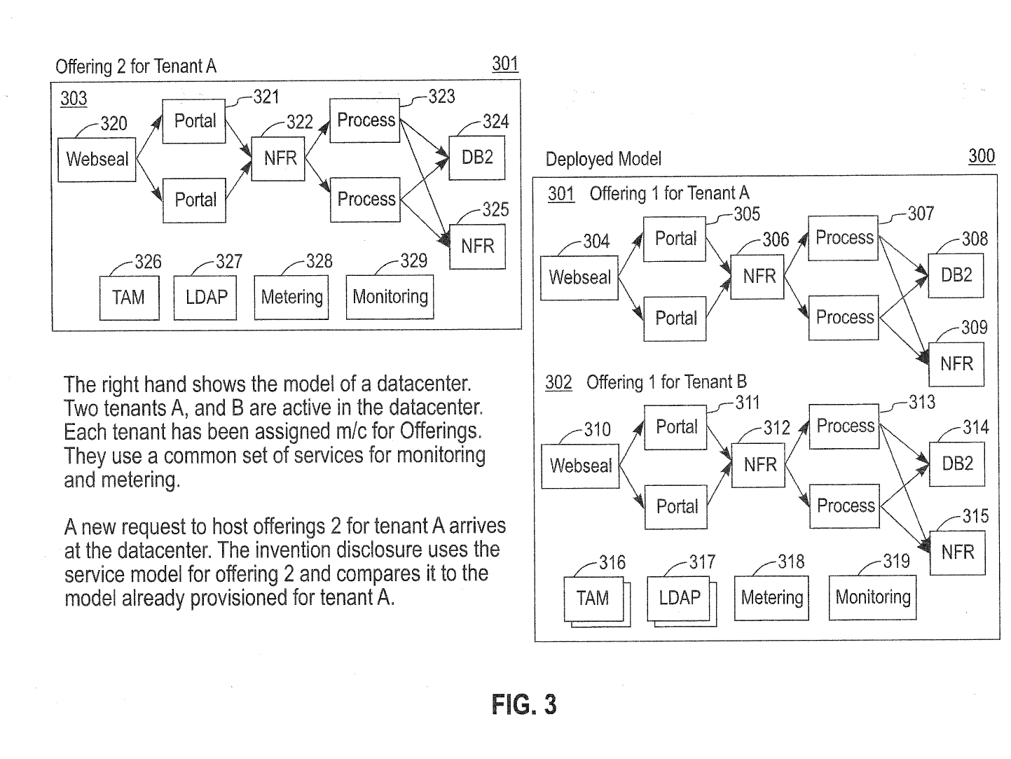

FIG. 3 uses an example of the logical topology of the IT resources in a data center and the logical topology of a new deployment request to better illustrate the logical steps involved in implementing the illustrative embodiment. The right side shows the current model of offerings and tenants in the datacenter to its IT resources (300). Two tenants A and B are active in the datacenter. Each tenant has been assigned managed configuration of IT resources for offerings 1 (301) and 2(302). Tenant A uses middleware resources such as WebSEAL (304), two clustered portal servers (305), NFR gateway (306), two clustered process servers (307) that use a DB2 server (308) and NFR Gateway (309). Similarly, tenant B uses middleware resources 310-315. Both tenants use a common set of services for monitoring (319) and metering (318), and both tenants also share TAM (316) and LDAP (317).

A new request to host offering 2 for tenant A (303) arrives at the datacenter. The offering 2 uses the same logical topology (320-329) as offering 1. The present invention uses the logical topology for offering 1 (302) for tenant A and compares it to the model already provisioned for tenant A (306).

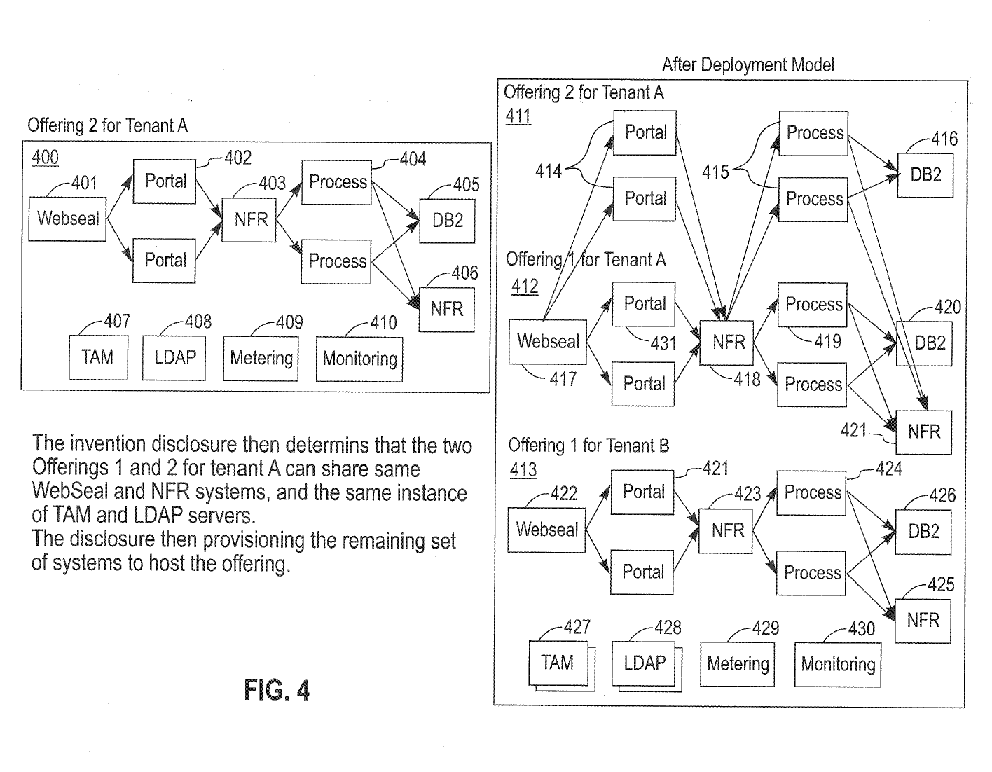

FIG. 4 continues the example and demonstrates how the configuration for the new request is determined in accordance with an illustrative embodiment. The preferred embodiment of the present invention determines that the two offerings 1(412) and 2 (411) for tenant A can share the same WebSEAL (412) and NFR (418) systems, and the same instance of TAM (427) and LDAP (428) servers, monitoring (430) and metering (429) services. Sharing constraints such as for example performance and security prevent sharing of Process (415, 419) and DB2 (416, 420) instances.

The preferred embodiment of the present invention then provisions the remaining set Of systems—in this case Portal (414), Process (415), and DB2 (416)—to host the offering.

While in this particular example, the middleware resources 304-309 and 310-315 are not shared between tenants A and B, they could be shared depending on both the offering' and the datacenter's sharing rules and constraints. For example, an offering could already include support for multiple tenants, in which case the choice of the resources to be shared will depend on offering-specific sharing rules. In another case, a datacenter's security constraints may allow sharing of WebSEAL servers between all offerings of the same tenants or all tenants deployed on the same WebSphere Process server cell. The performance constraints may restrict the number of tenants that can share the same WebSphere Process or Portal servers or decide if a new tenant can be added to the same cluster based on current workload and performance requirements.

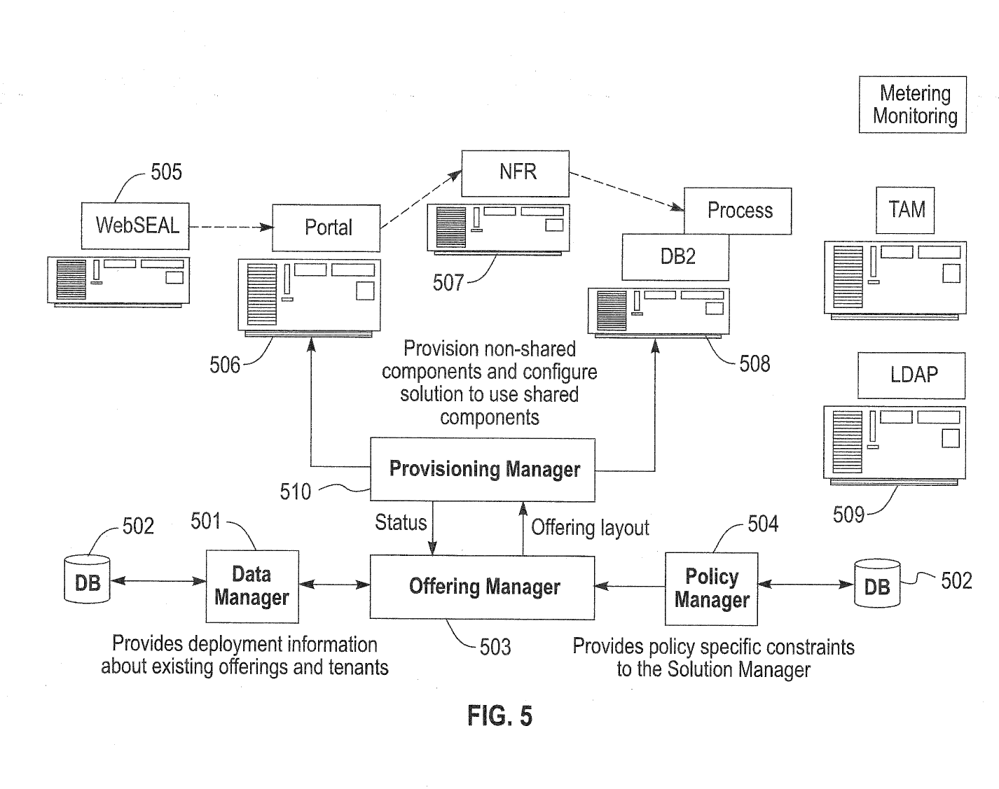

FIG. 5 depicts a schematic representation of the logical architecture of a system in accordance with an illustrative embodiment. Offering Manager (503) receives request to provision a new offering (as in 400 in FIG. 4) or to add a new tenant to an already provisioned offering and determines the offering's logical topology. Offering Manager (503) then calls the Data Manager (501) to obtain the information about the current configuration of the IT resources of the data center (as shown on the right side of FIG. 4) from the database (502). Offering Manager (503) then queries Policy Manager (504) to determine which of any of the currently provisioned resources can be shared with the new offering based on existing sharing rules and constraints.

Offering Manager {503) then calls Provisioning Manager (510) to provision the missing components and to configure the new offering/tenant to use shared components. In the particular example (FIG. 4), Provisioning Manager (510) provisions Portal server (506), DB2 and Process Server (508) and configures the new solution to use existing WebSEAL (505), NFR (507), LDAP, TAM, monitoring and metering services (509). In the particular example DB2 and Process Server (508) are collocated on the same blade while Portal Server (506) is deployed on a different blade, but other configurations can be found by those skilled in the art.

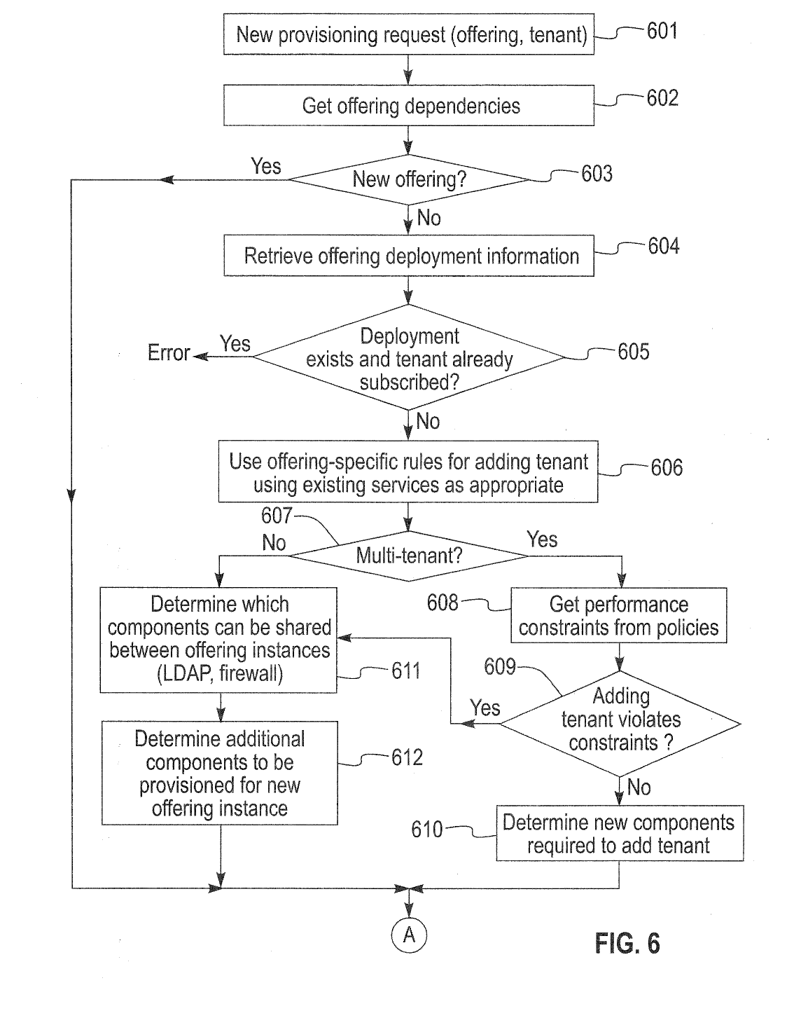

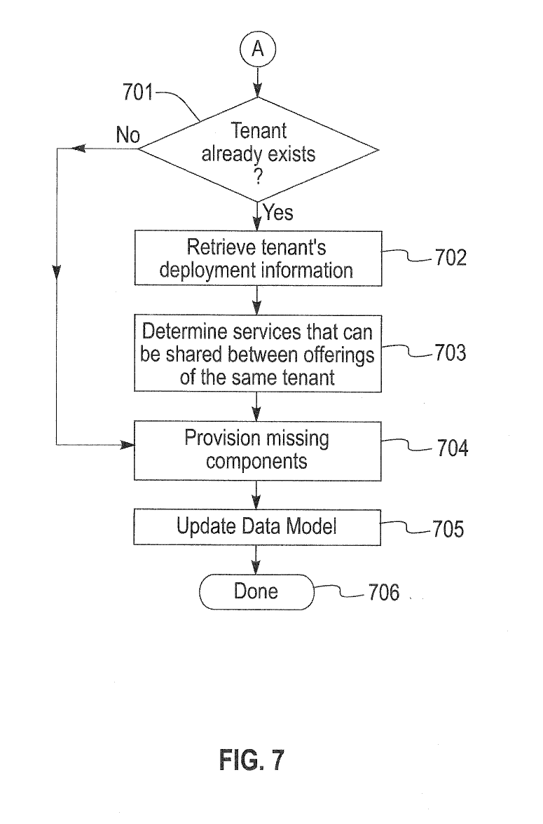

FIG. 6 is a first part of the flowchart illustrating the steps performed by the Offering Manager in accordance with an illustrative embodiment. When a Provision solution or add a new tenant request is received by the Offering Manager (503) from an external source in step 601, the Offering Manager retrieves the logical topology for the solution from the request. The Offering Manager then checks if the offering already exists (601) by querying the database (502) via the Data Manager (501). If it is a new offering, the provisioning continues as in FIG. 7. If one or more instance(s) of the offering have already been provisioned, the information about its current deployment topology and rules for adding a new tenant is obtained from the Data Manager (501) in step 606. If the offering supports multi-tenancy (607), Policy Manager (504) determines if the addition of another tenant as defined by the offering would violate the performance constraints defined in the policies (steps 608, 609).

An example of such a constraint would be an SLA requiring a specific response time from the offering that cannot be guaranteed by a shared component (e.g. WebSphere Process Server) in case of heavy workload that could potentially be generated by too many subscribers. A simpler policy can simply define the maximum number of tenants, whereas a more complex policy can take into consideration existing workload as well as potential workload generated after addition of the tenant. Other examples of policies would include those that define security constraints that may require that only offerings of a single tenant can share a single WebSEAL, or that multiple tenants can share a WebSEAL server, but that each group of offerings and tenants that share a specific WebSphere server cluster has its own WebSEAL server. Other examples would be that a single DB2 server can be used by all tenants and offerings or there could be multiple DB2 servers, or sharing of DB2 servers can be based on the amount of space on the machine and the size of databases or security constraints. Yet other examples of policies may deal with sharing of physical blades between various middleware resources; and, for example, DB2 server can be installed on the same blade as WebSphere Process Server or on a dedicated blade. In some embodiments, simulation can be done as well.

If the addition of the new tenant does not violate the constraints, the resources that can be shared and those that need to be provisioned are determined (610) based on specific offering rules. For example, some offerings may be implemented to share Process components and DB2 but require a new Portal component for each tenant; while other offerings may share all middleware components. If the addition of a new tenant would result in violation of the constraints (609), it is handled as the case of a single-tenant offering (611). In this case, the rules for sharing between offering instances are used (611). In the illustrative embodiment, the LDAP and firewall are shared, but other embodiments can be found by those skilled in the art. An example of another embodiment would be sharing of WebSphere Process Server between instances of different offerings, but not between instances of the same offering, or sharing of WebSphere Process Server between instances of different offerings only if such sharing is allowed by specific tenant's offering constraints.

FIG. 7 concludes the flowchart started in FIG. 6. Once the list of components to be provisioned is determined by the offering-based sharing rules as shown (FIG. 6), it may be further narrowed down if one of the components can be shared between all instances of the same tenant as illustrated in steps 701-703 on FIG. 7. This can be the case of a provisioning a completely new offering as well as the case when an existing tenant is subscribed to an existing offering. An example of the latter case would be a data center where a tenant A using an offering 1 decides to subscribe to an offering 2 an instance of which has already been provisioned for the tenant B, but not for the tenant A. The illustrative embodiment determines if the tenant already exists (701), obtains the deployment information about all components allocated to the tenant (702), determines which components can be shared between all offerings of the same tenant (regardless of the multi-tenancy support of the offering) (703) and which of the list determined in steps 610, 611 still need to be provisioned.

After the list of missing components is finalized, it is passed to the Provisioning Manager (510). Provisioning Manager then provisions the missing components (704) and notifies the Offering Manager about the provisioning status, and the Offering Manager then updates the database (via Data Manager's API) with the new information (705).

The invention can take the form of an entirely different hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of mapping a logical topology to information technology (IT) resources, comprising the steps of:
generating a logical topology of resources for a solution to a given request for resources;
extracting information about shared rules and constraints on IT resources specific to a plurality of customers; and
generating multiple mappings from the logical topology to the IT resources that satisfy said shared rules and constraints.

2. A method according to claim 1, wherein the step of generating multiple mappings includes the steps of:
obtaining information about currently provisioned resources; and
determining which of any of the currently provisioned resources can be shared in said solution based on said shared rules and constraints.

3. A method according to claim 2, wherein the step of generating multiple mappings includes the further step of configuring said solution to use the shared resources.

4. A method according to claim 3, wherein the step of generating the logical topology includes the step of checking to determine if the generated logical topology already exists.

5. A method according to claim 4, wherein the checking step includes the steps of:
maintaining a data base of records of logical topologies; and
querying said database to determine if said database includes a record of the generated logical topology.

6. A method according to claim 5, wherein the checking step includes the further step of, if the data base includes a record of the generated logical topology, obtaining rules for adding new tenants to said generated logical topology.

7. A method according to claim 6, wherein the step of generating multiple mappings includes the steps of:
determining a list of resources to be provisioned for the solution; and
removing from said list any of the resources that can be shared between all instances of the same tenant.

8. A system for mapping a logical topology to information technology (IT) resources, comprising:
an offering manager to generate a logical topology of resources for a solution to a given request for resources;
a data manager to provide information about shared rules and constraints on IT resources specific to a plurality of customers; and
a policy manager to generate multiple mapping from the logical topology to the IT resources that satisfy said shared rules and constraints.

9. A system according to claim 8, wherein:
the data manager provides information about currently provisioned IT resources; and

10. The offering manager determines which of any of the currently provisioned IT resources can be shared with the solution.

11. A system according to claim 9, further comprising a provisioning manager to provision missing resources and to configure said solution to use shared components.

12. A system according to claim 10, wherein the offering manager checks to determine if the generated logical topology already exists.

13. A system according to claim 11, further comprising a database holding records of logical topologies, and wherein the offering manager queries said database to determine if said database includes a record of the generated logical topology.

14. A system according to claim 12, wherein if the database includes a record of the generated logical topology, the offering manager obtains rules for adding new tenants to said generated logical topology.

15. A program storage device readable by machine, tangibly embodying a program of instructions executable by the machine to perform method steps for mapping a logical topology to information technology (IT) resources, the method steps comprising:
generating a logical topology of resources for a solution to a given request for resources;
extracting information about shared rules and constraints on IT resources specific to a plurality of customers; and
generating multiple mappings from the logical topology to the IT resources that satisfy said shared rules and constraints.

16. A program storage device according to claim 15, wherein the step of generating multiple mappings includes the steps of:
obtaining information about currently provisioned resources; and
determining which of any of the currently provisioned resources can be shared in said solution based on said shared rules and constraints.

17. A program storage device according to claim 15, wherein the step of generating multiple mappings includes the further step of configuring said solution to use the shared resources.

18. A program storage device according to claim 15, wherein the step of generating the logical topology includes the step of checking to determine if the generated logical topology already exists.

19. A program storage device according to claim 18, wherein the checking step includes the steps of:
maintaining a data base of records of logical topologies; and
querying said database to determine if said database includes a record of the generated logical topology.

20. A program storage device according to claim 18, wherein the checking step includes the further step of, if the data base includes a record of the generated logical topology, obtaining rules for adding new tenants to said generated logical topology.
